(19) United States
(12) Patent Application Publication
(10) Pub. No.: US 2026/0086365 A1
(43) Pub. Date: Mar. 26, 2026

(54) BLAZED GRATING, WAVEGUIDE AND DISPLAY DEVICE

(71) Applicant: ASUSTeK COMPUTER INC., Taipei City (TW)

(72) Inventors: Wen-Chang Hung, Taipei City (TW); Ting-Wei Huang, Taipei City (TW); Ji-Ping Sheng, Taipei City (TW); Bo-Kai Zhang, Taipei City (TW)

(73) Assignee: ASUSTeK COMPUTER INC., Taipei City (TW)

(21) Appl. No.: 19/211,319

(22) Filed: May 19, 2025

(30) Foreign Application Priority Data
Sep. 24, 2024 (TW) 113136147

(51) Int. Cl. G02B 27/01; G02B 6/34

(52) U.S. Cl. CPC G02B 27/0172; G02B 6/34; G02B 2027/0123

(57) ABSTRACT

A blazed grating, a waveguide, and a display device are provided. The blazed grating includes a blazed grating base and a plurality of sawtooth structures that are disposed on the blazed grating base. Each of the sawtooth structures includes a blazed surface and a secondary blazed surface. A blazed angle is formed between the blazed surface and a reference plane of the blazed grating base. The secondary blazed surface is opposite to the blazed angle. The blazed surface of each of the sawtooth structures is coated with at least one optical film layer group. Each of the at least one optical film layer group includes a first optical layer and a second optical layer. A refractive index of the first optical layer is higher than that of the second optical layer. The first and second optical layers of the at least one optical film layer group are periodically stacked alternately.

### CROSS-REFERENCE TO RELATED APPLICATION

This application claims the priority benefit of Taiwan application serial no. 113136147, filed on Sep. 24, 2024. The entirety of the above-mentioned patent application is hereby incorporated by reference herein and made a part of this specification.

### BACKGROUND

### Technical Field

The disclosure relates to a diffraction grating, an optical element, and an electronic device, and particularly relates to a blazed grating, a waveguide, and a display device.

### Description of Related Art

In the present consumer electronics market, head mounted displays (HMDs) are becoming increasingly popular in applications and research in the fields of virtual reality (VR) and augmented reality (AR).

Generally, in an optical module design of HMDs, optical characteristics of grating structures utilized as diffractive elements within waveguides directly impact key performance metrics of the HMDs, such as a field of view (FOV), output brightness, uniformity, and so on. Specifically, the grating structures currently employed in the waveguides include but are not limited to surface relief gratings (SRGs) and volume holographic gratings (VHGs).

However, the fabrication of the SRGs typically involves using nanoimprint technology to imprint microstructures on surfaces of the waveguides. The current limitations of the nanoimprint technology restrict the structural depth and height of the SRG microstructures to an upper limit of approximately 400 nanometers to 450 nanometers. Additionally, a refractive index values of an imprinting resin material and the waveguides also is limited to approximately 1.8 to 2. These upper limits directly adversely affect the maximum achievable diffraction efficiency and angular response bandwidth of the SRGs, leading to insufficient diffraction performance and angular response bandwidth in the SRGs. By contrast, in the VHGs, the limited refractive index difference in photosensitive materials used similarly results in an excessively narrow angular response bandwidth.

### SUMMARY

An embodiment of the disclosure provides a blazed grating, including a blazed grating base and a plurality of sawtooth structures. The sawtooth structures are disposed on the blazed grating base, where each of the sawtooth structures includes a blazed surface and a secondary blazed surface. A blazed angle is formed between the blazed surface and a reference plane of the blazed grating base, and the secondary blazed surface is opposite to the blazed angle. The blazed surface of each of the sawtooth structures is coated with at least one optical film layer group, and each of the at least one optical film layer group includes a first optical layer and a second optical layer. A refractive index of the first optical layer is higher than a refractive index of the second optical layer. The first optical layer and the second optical layer of the at least one optical film layer group are periodically stacked alternately and satisfy the following relation:

$${λ}_{B} = 2 * {n}_{eff} * {T}_{c} * cos ( φ - {θ}_{inc} ) ,$$

where λ_{B} is a working waveband of the blazed grating, n_{eff} is an equivalent refractive index of each of the at least one optical film layer group, T_{c} is a thickness of each of the at least one optical film layer group, θ_{inc} is a central FOV angle in action, and φ is the blazed angle.

Another embodiment of the disclosure further provides a waveguide configured to transmit an image light beam, including a plate body, at least one blazed grating, and at least one optical film. The plate body is located on a transmission path of the image light beam and has a coupling region and at least one pupil region, where the image light beam enters the at least one pupil region via the coupling region. The at least one blazed grating is correspondingly disposed on at least one of the coupling region and the at least one pupil region. The at least one optical film is correspondingly disposed on at least one of the coupling region and the at least one pupil region and correspondingly covers the at least one blazed grating. Each of the at least one blazed grating includes a blazed grating base and a plurality of sawtooth structures. The sawtooth structures are disposed on the blazed grating base, where each of the sawtooth structures includes a blazed surface and a secondary blazed surface. A blazed angle is formed between the blazed surface and a reference plane of the blazed grating base, and the secondary blazed surface is opposite to the blazed angle. The blazed surface of each of the sawtooth structures is coated with at least one optical film layer group, and each of the at least one optical film layer group includes a first optical layer and a second optical layer. A refractive index of the first optical layer is higher than a refractive index of the second optical layer. The first optical layer and the second optical layer of the at least one optical film layer group are periodically stacked alternately and satisfy the following relation:

$${λ}_{B} = 2 * {n}_{eff} * {T}_{c} * cos ( φ - {θ}_{inc} ) ,$$

where λ_{B} is a working waveband of the blazed grating, n_{eff} is an equivalent refractive index of each of the at least one optical film layer group, T_{c} is a thickness of each of the at least one optical film layer group, θ_{inc} is a central FOV angle in action, and φ is the blazed angle.

Another embodiment of the disclosure further provides a display device, including a display panel configured to provide an image light beam and a waveguide. The waveguide is configured to transmit the image light beam and includes a plate body, at least one blazed grating, and at least one optical film. The plate body is located on a transmission path of the image light beam and has a coupling region and at least one pupil region, where the image light beam enters the at least one pupil region via the coupling region. The at least one blazed grating is correspondingly disposed on at least one of the coupling region and the at least one pupil region. The at least one optical film is correspondingly disposed on at least one of the coupling region and the at least one pupil region and correspondingly covers the at least one blazed grating. Each of the at least one blazed grating includes a blazed grating base and a plurality of sawtooth structures. The sawtooth structures are disposed on the blazed grating base, where each of the sawtooth structures includes a blazed surface and a secondary blazed surface. A blazed angle is formed between the blazed surface and a reference plane of the blazed grating base, and the secondary blazed surface is opposite to the blazed angle. The blazed surface of each of the sawtooth structures is coated with at least one optical film layer group, and each of the at least one optical film layer group includes a first optical layer and a second optical layer. A refractive index of the first optical layer is higher than a refractive index of the second optical layer. The first optical layer and the second optical layer of the at least one optical film layer group are periodically stacked alternately and satisfy the following relation:

$${λ}_{B} = 2 * {n}_{eff} * {T}_{c} * cos ( φ - {θ}_{inc} ) ,$$

where λ_{B} is a working waveband of the blazed grating, n_{eff} is an equivalent refractive index of each of the at least one optical film layer group, T_{c} is a thickness of each of the at least one optical film layer group, θ_{inc} is a central FOV angle in action, and φ is the blazed angle.

In view of the above, the blazed grating, the waveguide, and the display device provided in one or more embodiments of this disclosure may, through the configuration of at least one optical film layer group on each of the sawtooth structures of the blazed grating and the adjustment of the thickness of the at least one optical film layer group, ensure the diffraction condition of the blazed grating to satisfy the Bragg regime condition, thereby enabling the blazed grating to have good diffraction efficiency and a relatively broad angular bandwidth. Besides, by adjusting the thickness of each of the at least one optical film layer group of the blazed grating located in different regions, the blazed grating may be applied to meet various requirements, thus ensuring wide applicability, which in turn enables both the waveguide and the display device to have good optical performance.

To make the above-mentioned features and advantages of this disclosure more apparent and understandable, embodiments are provided below with detailed explanations in conjunction with the accompanying drawings as follows.

### BRIEF DESCRIPTION OF THE DRAWINGS

FIG. 1 is a schematic view illustrating a light path of a display device according to an embodiment of this disclosure.

FIG. 2A is a schematic view illustrating a structure of the waveguide depicted in FIG. 1.

FIG. 2B is a schematic cross-sectional view illustrating a partial region of the waveguide depicted in FIG. 2A.

FIG. 2C is a schematic enlarged cross-sectional view illustrating the blazed grating depicted in FIG. 2B.

FIG. 2D and FIG. 2E are schematic enlarged cross-sectional views illustrating other blazed gratings according to an embodiment of this disclosure.

FIG. 3A and FIG. 3B are schematic views of relation curves showing an angular response bandwidth of a blazed grating according to different embodiments of this disclosure.

FIG. 4A and FIG. 4B are schematic views of relation curves showing a wavelength response bandwidth of a blazed grating according to different embodiments of this disclosure.

FIG. 5 is a schematic view of relation curves showing an angular response bandwidth of a blazed grating (Bragg) according to an embodiment of this disclosure and a surface relief grating (Raman-Nath) according to a comparative example.

FIG. 6A is a schematic view of a relation curve showing a total thickness of an optical film layer group and a diffraction efficiency of the blazed grating disposed in the coupling region depicted in FIG. 1.

FIG. 6B is a schematic view of a relation curve showing a total thickness of an optical film layer group and a diffraction efficiency of the blazed grating disposed in the at least one pupil expansion region depicted in FIG. 1.

### DESCRIPTION OF THE EMBODIMENTS

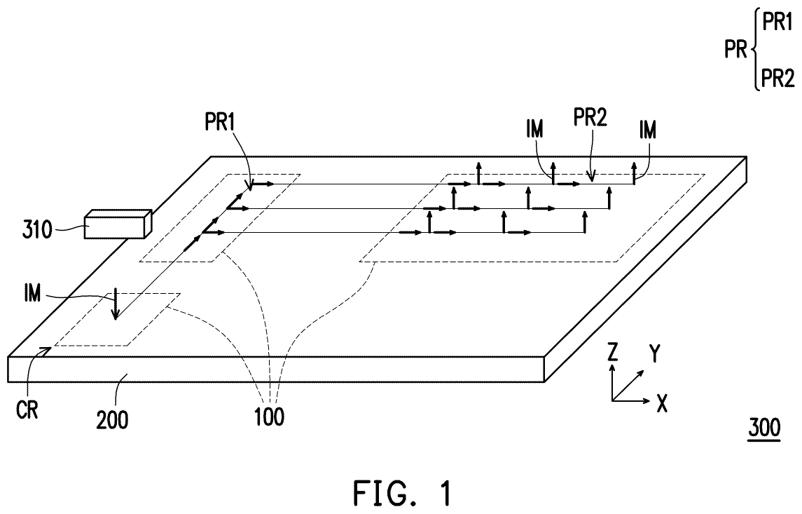

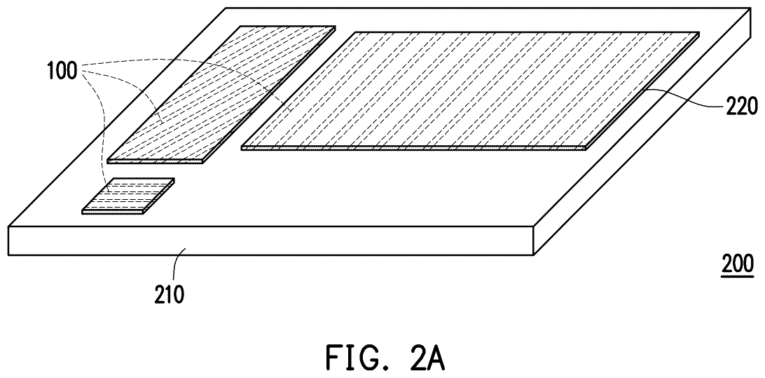

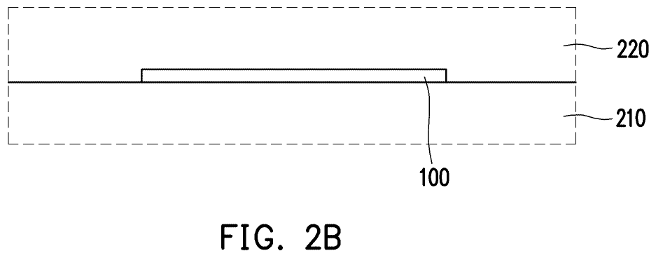

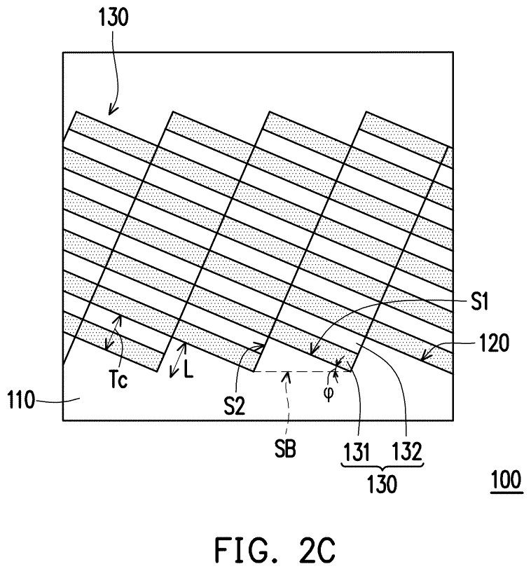

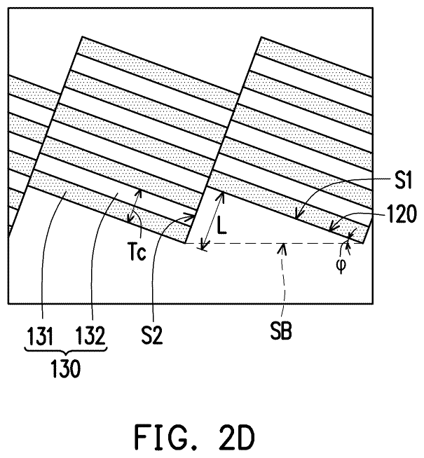

FIG. 1 is a schematic view illustrating a light path of a display device according to an embodiment of this disclosure. FIG. 2A is a schematic view illustrating a structure of the waveguide depicted in FIG. 1. FIG. 2B is a schematic cross-sectional view illustrating a partial region of the waveguide depicted in FIG. 2A. FIG. 2C is a schematic enlarged cross-sectional view illustrating the blazed grating depicted in FIG. 2B. FIG. 2D and FIG. 2E are schematic enlarged cross-sectional views illustrating other blazed gratings according to an embodiment of this disclosure. With reference to FIG. 1 to FIG. 2C, a display device 300 provided in this embodiment includes a display panel 310 and a waveguide 200, where the display panel 310 is configured to provide an image light beam IM, and the waveguide 200 is configured to transmit the image light beam IM. Specifically, as shown in FIG. 1 to FIG. 2C, in this embodiment, the waveguide 200 includes a plate body 210, at least one blazed grating 100, and at least one optical film 220. The plate body 210 is located on a transmission path of the image light beam IM and has a coupling region CR and at least one pupil expansion region PR. The at least one blazed grating 100 is correspondingly disposed on at least one of the coupling region CR and the at least one pupil expansion region PR.

Specifically, as shown in FIG. 1, in this embodiment, the image light beam IM provided by the display panel 310 enters the at least one pupil expansion region PR via the coupling region CR. The blazed grating 100 disposed in the coupling region CR guides the image light beam IM into the plate body 210 of the waveguide 200 and ensures a diffraction angle of the image light beam IM to be greater than a critical angle, thereby enabling the image light beam IM to be transmitted in a Total Internal Reflection (TIR) manner to the blazed grating 100 disposed in the at least one pupil expansion region PR. The blazed grating 100 disposed in the at least one pupil expansion region PR, in addition to transmitting the image light beam IM, further performs light division and beam expansion on the image light beam IM within the at least one pupil expansion region PR, thus achieving pupil expansion. For instance, as shown in FIG. 1, in this embodiment, the at least one pupil expansion region PR includes a first pupil expansion region PR1 and a second pupil expansion region PR2. The blazed grating 100 disposed in the first pupil expansion region PR1 enables the image light beam IM to undergo light division and beam expansion in a y direction, thus achieving pupil expansion in the y direction. On the other hand, the blazed grating 100 disposed in the second pupil expansion region PR2 enables the image light beam IM to undergo light division and beam expansion in an x direction, thus achieving pupil expansion in the x direction. As such, after passing through the first pupil expansion region PR1 and the second pupil expansion region PR2, the image light beam IM is expanded into an area light beam of a certain size. The blazed grating 100 disposed in the second pupil expansion region PR2, while achieving pupil expansion of the image light beam IM in the x direction, further guides the image light beam IM out of the waveguide 200, allowing the image light beam IM to be transmitted to human eyes.

In addition, in this embodiment, the at least one optical film 220 is correspondingly disposed on one of the coupling region CR and the at least one pupil expansion region PR and correspondingly covers at least one blazed grating 100. For instance, in this embodiment, a refractive index of the at least one optical film 220 ranges from 1.5 to 1.8, and a thickness of the at least one optical film 220 ranges from 1 micrometer to 3 micrometers. As such, light efficiency loss caused by repeated diffraction during the TIR process of the image light beam IM in the waveguide 200 may be reduced.

In this embodiment, note that although the waveguide 200 of the display device 300 is exemplified by the layout of the coupling region CR and the at least one pupil expansion region PR, the disclosure is not limited thereto. The waveguide 200 of the display device 300 may have various layouts, as long as the waveguide 200 is able to guide the entry of the image light beam IM and perform pupil expansion.

Further explanation of the structural design and the optical characteristics of the blazed grating 100 will be provided below with reference to FIG. 2C to FIG. 6.

Specifically, as shown in FIG. 2C, in this embodiment, the blazed grating 100 includes a blazed grating base 110 and a plurality of sawtooth structures 120. The sawtooth structures 120 are disposed on the blazed grating base 110, where each of the sawtooth structures 120 includes a blazed surface S1 and a secondary blazed surface S2. A blazed angle q is formed between the blazed surface S1 and a reference plane SB of the blazed grating base 110, and the secondary blazed surface S2 is opposite to the blazed angle q. The blazed surface S1 of each of the sawtooth structures 120 is coated with at least one optical film layer group 130, and each at least one optical film layer group 130 includes a first optical layer 131 and a second optical layer 132. A refractive index of the first optical layer 131 is higher than a refractive index of the second optical layer 132. The first optical layer 131 and the second optical layer 132 of the at least one optical film layer group 130 are periodically stacked alternately.

For instance, in this embodiment, the blazed grating 100 may be completed on the plate body 210 of the waveguide 200 by nanoimprint or etching process, which means that the blazed grating base 110 and the sawtooth structures 120 are part of the plate body 210 of the waveguide 200. Then, a coating process of the first optical layer 131 with a high refractive index and the second optical layer 132 with a low refractive index is repeatedly performed on the blazed grating 100. In this embodiment, there is no specific restriction to an order of coating the first optical layer 131 and the second optical layer 132, as long as the first optical layer 131 and the second optical layer 132 of the at least one optical film layer group 130 are periodically stacked alternately. In addition, a coating direction of the first optical layer 131 and the second optical layer 132 during coating is parallel to the secondary blazed surface S2 to avoid being blocked by the secondary blazed surface S2. As such, each at least one optical film layer group 130 may completely cover the blazed surface S1 of each of the sawtooth structures 120 through a simple process, and the first optical layer 131 and the second optical layer 132 of each at least one optical film layer group 130 may be uniformly formed on the blazed surface S1 of each of the sawtooth structures 120.

In this embodiment, working wavebands of the blazed grating base 110 of the blazed grating 100 and the first optical layer 131 and the second optical layer 132 of the at least one optical film layer group 130 are all ranged from 380 nanometers to 750 nanometers, and materials of the blazed grating base 110 and the first optical layer 131 and the second optical layer 132 may be the same or different types of materials. For instance, the materials of the blazed grating base 110 and the first optical layer 131 and the second optical layer 132 all need to work in a visible light waveband, and the selected material of the three may be the same or different. The material of the blazed grating base 110 is limited by the process method. The material of the blazed grating base 110 on which the sawtooth structures 120 are made by nanoimprint is mainly resin where materials with high refractive index materials are added, including titanium oxide, cerium dioxide, or doped with nanoparticles such as silicon dioxide, zirconium oxide, uniformly dispersed in the resin to increase the refractive index, with an achievable upper limit of the refractive index of 1.8 to 2. On the other hand, for the blazed grating base 110 with the sawtooth structures 120 made by the etching process, materials such as gallium nitride, gallium arsenide, silicon nitride, silicon dioxide, aluminum nitride, silicon, titanium dioxide, or other metal materials with the high refractive index, such as aluminum, silver, gold, may be used, with an achievable upper limit of the refractive index higher than an achievable upper limit of the refractive index in the nanoimprint process. On the other hand, a coating material for the first optical layer 131 with the high refractive index may include titanium dioxide, while a coating material for the second optical layer 132 with the low refractive index may include silicon oxide, silicon fluoride, aluminum oxide, and so on. Besides, in this embodiment, the refractive indices of the first optical layer 131 and the second optical layer 132 range from 1.5 to 3.4, which may also be higher than the upper limit of the refractive index in the nanoimprint process.

In addition, as shown in FIG. 2C, in this embodiment, a thickness Tc of each at least one optical film layer group 130 of any sawtooth structure 120 is equal to a length L of the secondary blazed surface S2 of the adjacent sawtooth structure 120. In other words, as shown in FIG. 2C, in this embodiment, boundaries of each at least one optical film layer group 130 of the adjacent sawtooth structures 120 are connected, which should however not be construed as a limitation in the disclosure. As shown in FIG. 2D, in another embodiment, the thickness Tc of each at least one optical film layer group 130 of any sawtooth structure 120 of the blazed grating 100 may also be unequal to the length L of the secondary blazed surface S2 of the adjacent sawtooth structure 120. As such, misalignment may occur at the boundaries of each at least one optical film layer group 130 of the adjacent sawtooth structures 120. Moreover, in this embodiment, although it is exemplified that each of the sawtooth structures 120 has a plurality of optical film layer groups 130, the disclosure is not limited to thereto. As shown in FIG. 2E, in another embodiment, each of the sawtooth structures 120 of the blazed grating 100 may further have only one optical film layer group 130, which may achieve similar functions.

Furthermore, in this embodiment, a design range of optical parameters of the blazed grating 100 may be determined sequentially by product specification requirements.

For instance, a grating period of the blazed grating 100 may be determined first according to the requirements of various parameters, such as the working waveband of the blazed grating 100, the size of the FOV of the device, and the refractive index of the blazed grating base 110. Taking the working waveband as a green light wavelength (i.e., 530 nanometers), the FOV as 30°, and the refractive index of the blazed grating base 110 as 1.6 as an example, in the situation where the diffraction angle is required to satisfy the total reflection condition and be greater than the critical angle, it may be derived that the diffraction angle may range from 38 degrees to 90 degrees, and its grating period may range from 390 nanometers to 430 nanometers. When the working waveband of the blazed grating 100 is in a visible light waveband (i.e., 400 nanometers to 800 nanometers), its grating period may range from 280 nanometers to 650 nanometers.

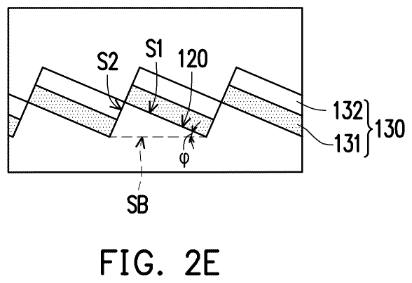

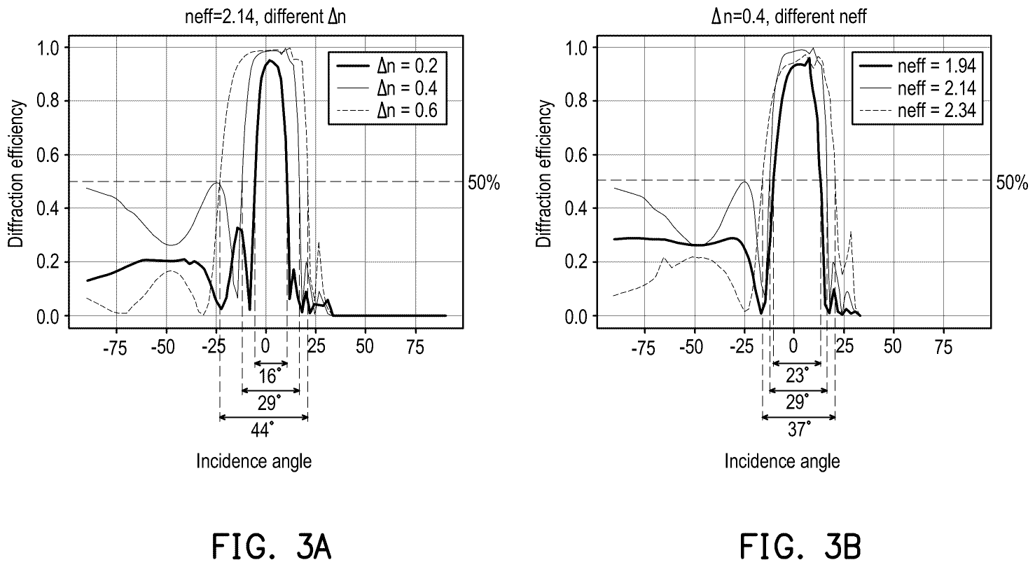

FIG. 3A and FIG. 3B are schematic views of relation curves showing an angular response bandwidth of the blazed grating 100 according to different embodiments of this disclosure. FIG. 4A and FIG. 4B are schematic views of relation curves showing a wavelength response bandwidth of the blazed grating 100 according to different embodiments of this disclosure. On the other hand, the parameter design of the equivalent refractive index (n_{eff}) and the refractive index difference (Δn) of the first optical layer 131 and the second optical layer 132 of at least one optical film layer group 130 may impact the wavelength response bandwidth and angular response bandwidth of the blazed grating 100. As shown in FIG. 3A and FIG. 3B, the equivalent refractive index and the refractive index difference of the first optical layer 131 and the second optical layer 132 of the at least one optical film layer group 130 have a positive correlation with the angular response bandwidth of the blazed grating 100. On the other hand, as shown in FIG. 4A and FIG. 4B, the refractive index difference of the first optical layer 131 and the second optical layer 132 of the at least one optical film layer group 130 has a positive correlation with the wavelength response bandwidth of the blazed grating 100, while the equivalent refractive index does not affect the wavelength response bandwidth. Hence, in this embodiment, the parameter range of the refractive index of the first optical layer 131 and the refractive index of the second optical layer 132 may also be designed according to the wavelength response bandwidth requirements of the product. For instance, when the refractive index difference between the first optical layer 131 and the second optical layer 132 is set to 0.4, the resultant wavelength response bandwidth may be approximately 54 nanometers. Moreover, by adjusting the equivalent refractive index of the first optical layer 131 and the second optical layer 132 of the at least one optical film layer group 130, the blazed grating 100 may obtain a relatively broad angular response bandwidth.

On the other hand, generally, depending on different diffraction conditions, the diffracted light passing through a grating may operate under either the Raman-Nath regime or the Bragg regime. Under the Raman-Nath regime, incident light is diffracted into multiple orders of diffracted light after passing through a medium, while under the Bragg regime conditions only zero-order and first-order diffraction occurs when a light beam incident at a Bragg angle passes through the medium. Due to the extremely high reflection efficiency and the relatively broad angular bandwidth under the Bragg regime conditions, the optical parameters of the blazed grating 100 may be designed to satisfy the following relation, ensuring that the blazed grating 100 satisfies the Bragg regime conditions:

$${λ}_{B} = 2 * {n}_{eff} * {T}_{c} * cos ( φ - {θ}_{inc} ) ,$$

where λ_{B} is a working waveband of the blazed grating 100, n_{eff} is an equivalent refractive index of each of the at least one optical film layer group 130, T_{c} is a thickness of each of the at least one optical film layer group 130, θ_{inc} is a central FOV angle in action, and φ is the blazed angle.

As such, after determining the working waveband of the blazed grating 100, the central FOV angle in action, and the equivalent refractive index of each of the at least one optical film layer group 130 based on the product specification requirements, the parameter ranges of the thickness Tc of each of the at least one optical film layer group 130 and the blazed angle φ may be determined through the above relation. Moreover, in this embodiment, since the thickness Tc of each of the at least one optical film layer group 130 may not be subject to the upper limit constraint on thickness imposed by the nanoimprint process, it may allow an SRG structure which may originally only satisfy the Raman-Nath regime conditions to be transformed into an SRG structure conforming to the Bragg regime conditions through the configuration of the at least one optical film layer group 130 and the adjustment of its thickness Tc, thereby enabling the blazed grating 100 to have good diffraction efficiency and a relatively broad angular bandwidth.

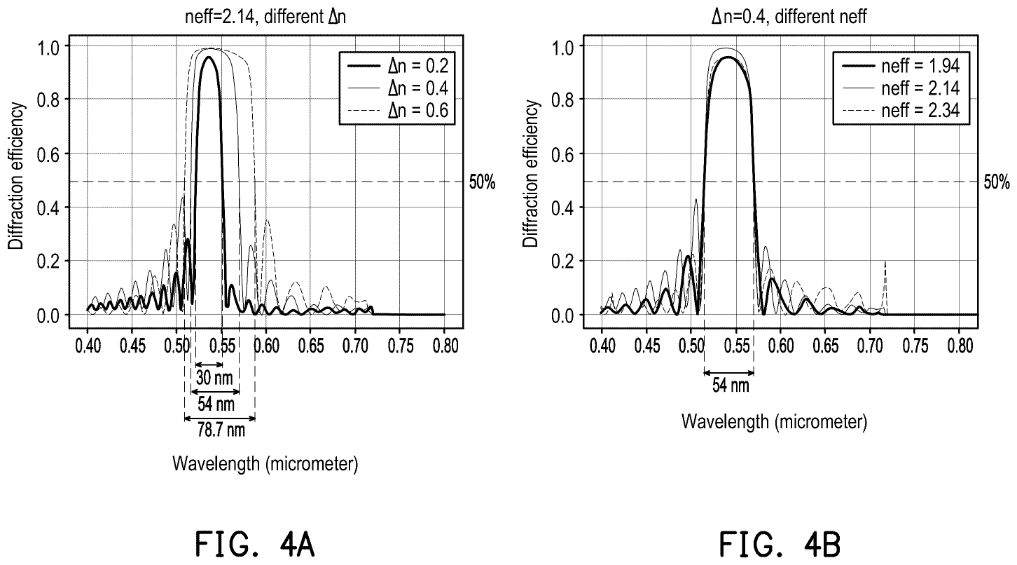

FIG. 5 is a schematic view of relation curves showing an angular response bandwidth of the blazed grating 100 according to an embodiment of this disclosure and a surface relief grating (Raman-Nath) according to a comparative example. As shown in FIG. 5, in this embodiment, compared to the SRG conforming to the Raman-Nath regime conditions, the blazed grating 100, through the configuration of the at least one optical film layer group 130 and the adjustment of its thickness Tc, may have the angular response bandwidth increased by about 20 degrees. Moreover, within the range of its angular response bandwidth, its diffraction efficiency is further improved by nearly 10%.

On the other hand, since the blazed grating 100 located in different regions of the waveguide 200 may require different diffraction efficiencies due to actual application needs so as to ensure good uniformity of the final output image light beam IM. For instance, the blazed grating 100 disposed in the coupling region CR needs to guide all the image light beams IM into the waveguide 200 and requires a relatively high diffraction efficiency, while the blazed grating 100 disposed in the at least one pupil region PR needs to perform light division and thus requires the adjustment of diffraction efficiency according to spatial zoning. Moreover, since the adjustment of the total thickness of each of the at least one optical film layer group 130 of the blazed grating 100 may be serve to control the diffraction efficiency, in this embodiment, the total thickness of each of the at least one optical film layer group 130 of the blazed grating 100 located in different regions may also be adjusted to satisfy actual application requirements.

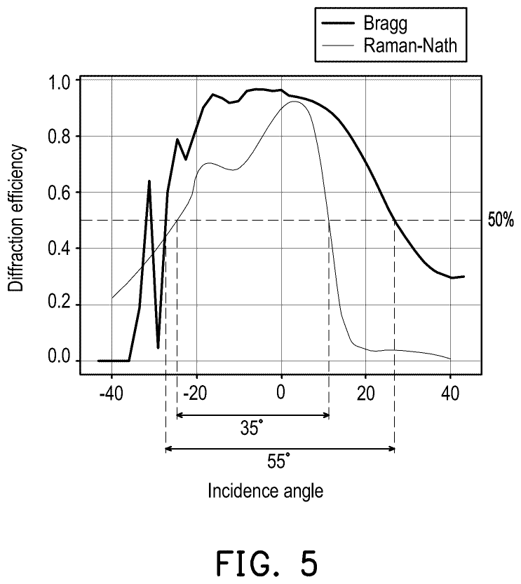

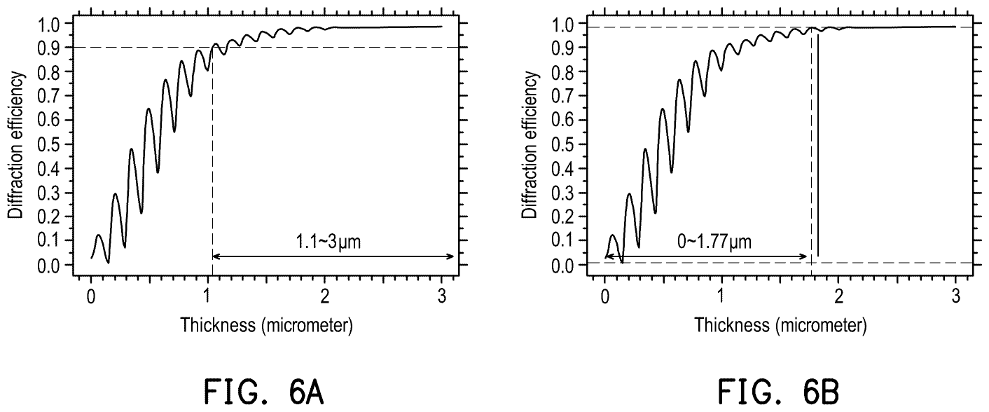

For instance, FIG. 6A is a schematic view of a relation curve showing a total thickness of the optical film layer group 130 and a diffraction efficiency of the blazed grating 100 disposed in the coupling region CR depicted in FIG. 1. FIG. 6B is a schematic view of a relation curve showing a total thickness of an optical film layer group and a diffraction efficiency of the blazed grating 100 disposed in the at least one pupil expansion region PR depicted in FIG. 1. As shown in FIG. 6A and FIG. 6B, in this embodiment, the total thickness of each of the at least one optical film layer group 130 of the blazed grating 100 correspondingly disposed in the coupling region CR may range from 1.1 micrometers to 3 micrometers, so as to enable the blazed grating 100 to have a good diffraction efficiency of, for instance, greater than 90%. On the other hand, the total thickness of each of the at least one optical film layer group 130 of the blazed grating 100 correspondingly disposed in the at least one pupil region PR is less than 1.77 micrometers, which may allow the sawtooth structures 120 at various locations of the blazed grating 100 to have different thicknesses, so as to adjust the diffraction efficiency in different spatial zones, allow the diffraction efficiency to range from 0% to 98%, and enable the final output image light beam IM to have good uniformity.

To sum up, the blazed grating, the waveguide, and the display device provided in one or more embodiments this disclosure, through the configuration of the at least one optical film layer group on each of the sawtooth structures of the blazed grating and the adjustment of the thickness, may enable the diffraction condition of the blazed grating to satisfy the Bragg regime condition, thereby allowing the blazed grating to have good diffraction efficiency and a relatively broad angular bandwidth. Moreover, by adjusting the thickness of each of the at least one optical film layer group of the blazed grating located in different regions, the blazed grating may be applied to meet various requirements, thus ensuring wide applicability, which in turn enables both the waveguide and the display device to have good optical performance.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A blazed grating, comprising:
a blazed grating base; and
a plurality of sawtooth structures, disposed on the blazed grating base, wherein each of the sawtooth structures comprises a blazed surface and a secondary blazed surface, a blazed angle is formed between the blazed surface and a reference plane of the blazed grating base, the secondary blazed surface is opposite to the blazed angle, the blazed surface of each of the sawtooth structures is coated with at least one optical film layer group,
each of the at least one optical film layer group comprises a first optical layer and a second optical layer, a refractive index of the first optical layer is higher than a refractive index of the second optical layer, and the first optical layer and the second optical layer of the at least one optical film layer group are periodically stacked alternately and satisfy a following relation:
$${λ}_{B} = 2 * {n}_{eff} * {T}_{c} * cos ( φ - {θ}_{inc} ) ,$$
wherein λ_{B} is a working waveband of the blazed grating, n_{eff} is an equivalent refractive index of each of the at least one optical film layer group, T_{c} is a thickness of each of the at least one optical film layer group, θ_{inc} is a central field of view angle in action, and φ is the blazed angle.

2. The blazed grating according to claim 1, wherein each of the at least one optical film layer group completely covers the blazed surface of each of the sawtooth structures.

3. The blazed grating according to claim 1, wherein the thickness of each of the at least one optical film layer group of any of the sawtooth structures is equal to a length of the secondary blazed surface of another of the sawtooth structures adjacent to the any of the sawtooth structures.

4. The blazed grating according to claim 1, wherein the refractive indices of the first optical layer and the second optical layer range from 1.5 to 3.4.

5. A waveguide, configured to transmit an image light beam and comprising:
a plate body, located on a transmission path of the image light beam and having a coupling region and at least one pupil expansion region, the image light beam entering the at least one pupil expansion region via the coupling region;
at least one blazed grating, correspondingly disposed on at least one of the coupling region and the at least one pupil expansion region, each of the at least one blazed grating comprising:
a blazed grating base; and
a plurality of sawtooth structures, disposed on the blazed grating base, wherein each of the sawtooth structures comprises a blazed surface and a secondary blazed surface, a blazed angle is formed between the blazed surface and a reference plane of the blazed grating base, the secondary blazed surface is opposite to the blazed angle, each of the blazed surfaces of the sawtooth structures is coated with at least one optical film layer group,
each of the at least one optical film layer group comprises a first optical layer and a second optical layer, a refractive index of the first optical layer is higher than a refractive index of the second optical layer, and the first optical layer and the second optical layer of the at least one optical film layer group are periodically stacked alternately and satisfy a following relation:
$${λ}_{B} = 2 * {n}_{eff} * {T}_{c} * cos ( φ - {θ}_{inc} ) ,$$
wherein λ_{B} is a working waveband of the blazed grating, n_{eff} is an equivalent refractive index of each of the at least one optical film layer group, T_{c} is a thickness of each of the at least one optical film layer group, θ_{inc} is a central field of view angle in action, and φ is the blazed angle; and
at least one optical film, correspondingly disposed on at least one of the coupling region and the at least one pupil expansion region and correspondingly covering the at least one blazed grating.

6. The waveguide according to claim 5, wherein each of the at least one optical film layer group completely covers the blazed surface of each of the sawtooth structures.

7. The waveguide according to claim 5, wherein the thickness of each of the at least one optical film layer group of any of the sawtooth structures is equal to a length of the secondary blazed surface of another of the sawtooth structures adjacent to the any of the sawtooth structures.

8. The waveguide according to claim 5, wherein the refractive indices of the first optical layer and the second optical layer range from 1.5 to 3.4.

9. The waveguide according to claim 5, wherein a refractive index of the at least one optical film ranges from 1.5 to 1.8.

10. The waveguide according to claim 5, wherein the thickness of the at least one optical film ranges from 1 micrometer to 3 micrometers.

11. The waveguide according to claim 5, wherein one of the at least one blazed grating is correspondingly disposed on the coupling region, and a total thickness of each of the at least one optical film layer group of the one of the at least one blazed grating ranges from 1.1 micrometers to 3 micrometers.

12. The waveguide according to claim 5, wherein one of the at least one blazed grating is correspondingly disposed on the at least one pupil expansion region, and a total thickness of each of the at least one optical film layer group of the one of the at least one blazed grating is less than 1.77 micrometers.

13. A display device, comprising:
a display panel, configured to provide an image light beam; and
a waveguide, comprising:
a plate body, located on a transmission path of the image light beam and having a coupling region and at least one pupil expansion region, the image light beam entering the at least one pupil expansion region via the coupling region;
at least one blazed grating, correspondingly disposed on at least one of the coupling region and the at least one pupil expansion region, each of the at least one blazed grating comprising:
a blazed grating base; and
a plurality of sawtooth structures, disposed on the blazed grating base, wherein each of the sawtooth structures comprises a blazed surface and a secondary blazed surface, a blazed angle is formed between the blazed surface and a reference plane of the blazed grating base, the secondary blazed surface is opposite to the blazed angle, the blazed surface of each of the sawtooth structures is coated with at least one optical film layer group,
each of the at least one optical film layer group comprises a first optical layer and a second optical layer, a refractive index of the first optical layer is higher than a refractive index of the second optical layer, and the first optical layer and the second optical layer of the at least one optical film layer group are periodically stacked alternately and satisfy a following relation:
$${λ}_{B} = 2 * {n}_{eff} * {T}_{c} * cos ( φ - {θ}_{inc} ) ,$$
wherein λ_{B} is a working waveband of the blazed grating, n_{eff} is an equivalent refractive index of each of the at least one optical film layer group, T_{c} is a thickness of each of the at least one optical film layer group, θ_{inc} is a central field of view angle in action, and φ is the blazed angle; and
at least one optical film, correspondingly disposed on at least one of the coupling region and the at least one pupil expansion region and correspondingly covering the at least one blazed grating.

14. The display device according to claim 13, wherein each of the at least one optical film layer group completely covers the blazed surface of each of the sawtooth structures.

15. The display device according to claim 13, wherein the thickness of each of the at least one optical film layer group of any of the sawtooth structures is equal to a length of the secondary blazed surface of another of the sawtooth structures adjacent to the any of the sawtooth structures.

16. The display device according to claim 13, wherein the refractive indices of the first optical layer and the second optical layer range from 1.5 to 3.4.

17. The display device according to claim 13, wherein a refractive index of the at least one optical film ranges from 1.5 to 1.8.

18. The display device according to claim 13, wherein the thickness of the at least one optical film ranges from 1 micrometer to 3 micrometers.

19. The display device according to claim 13, wherein one of the at least one blazed grating is correspondingly disposed on the coupling region, and a total thickness of each of the at least one optical film layer group of the one of the at least one blazed grating ranges from 1.1 micrometers to 3 micrometers.

20. The display device according to claim 13, wherein one of the at least one blazed grating is correspondingly disposed on the at least one pupil expansion region, and a total thickness of each of the at least one optical film layer group of the one of the at least one blazed grating is less than 1.77 micrometers.
